(19) United States
(12) Patent Application Publication
(10) Pub. No.: US 2003/0020007 A1
(43) Pub. Date: Jan. 30, 2003

(54) Tracking furrow with laser

(76) Inventor: Hans Jorgen Andersen, Hjallerup (DK)

Correspondence Address: Browdy & Neimark, Suite 300, 624 Ninth Street NW, Washington, DC, 20001-5303, US

(21) Appl. No.: 10/169,715

(22) PCT Filed: Jan. 11, 2001
(86) PCT No.: PCT/DK01/00019

(30) Foreign Application Priority Data
Jan. 12, 2000 (DK) PA 2000 00041

(51) Int. Cl. G06M 7/00; H01J 40/14

(52) U.S. Cl. 250/221; 250/559.4

(57) ABSTRACT

According to the method a laser light source (10), which in a beam direction (14) exposes a line (13), and a light detector (9) capable of taking a picture with a certain resolution and having a line of sight (12), are mounted on a vehicle (1) or implement (5) with a travelling direction (P) in such a manner that a line (13) exposed by the laser light source (10) in the field is transverse to the travelling direction (P), that the light detector (9) aims at the line (13) exposed by the laser light source (10), the line of sight (12) of the light detector (8) and the beam direction (14) of the laser light source (10) forming an angle (alpha) in a plane transverse to the exposed line (13). The light detector (9) takes a picture of the exposed line (13) and the picture taken by the light detector (9) of the exposed line (13) in the field is analysed with a view to determining extreme value points (18), bends or the like characteristics in the picture of the line (13).

The present invention relates to a method of detecting a track in the shape of an elongated furrow or a ridge in a field. The invention further relates to a combination of an agricultural implement and a drive unit with a travelling direction. Finally, the invention relates to a detecting unit. By the term agricultural implement is in particular to be understood a farm implement, a horticultural implement or a forestry implement.

It is for instance known from European patent application no. 83108712.7 and Danish patent application no. PA 1997 01269 to create a furrow in the field with a view to subsequently following it to guide an implement or a tractor. It is in this connection known to follow the furrow by means of mechanical means as described for instance in said Danish patent application no. PA 1997 01269 and the U.S. Pat. Nos. 4,184,551 and 4,607,716. It is, however, not without problems to use such a mechanical following of the track, as the furrow or the track, depending on the properties of the soil of the field in question, may easily be spoiled such that it cannot be followed in a satisfactory manner by the mechanical means.

It is furthermore known from for instance U.S. Pat. Nos. 5,442,552 and 4,868,752 to guide a tractor or an implement by optical detection of plants or lines in the field, for instance the dividing line between cut or uncut grass.

Mechanical track following may, as mentioned, present problems, as a fairly deep track is required, and these tracks tend to become spoiled. Optical track following in a bare field is problematic too, as the contours of the field may be difficult to detect depending on the light conditions.

The object of the present invention is to provide a method of track following in a field, by which method the above-mentioned problem are obviated.

This object is met by a method mentioned by way of introduction, which is characterized in that a laser light source, which in a beam direction exposes a line, and a light detector capable of taking a picture with a certain resolution and having a line of sight, are mounted on a vehicle or implement with a travelling direction in such a manner that a line exposed by the laser light source in the field is transverse to the travelling direction, that the light detector aims at the line exposed by the laser light source, that the line of sight of the light detector and the beam direction of the laser light source form an angle in a plane transverse to the exposed line, that the light detector takes a picture of the exposed line, and that the picture taken by the light detector of the exposed line in the field is analyzed with a view to determining extreme value points, bends or the like characteristics in the picture of the line.

The laser light source and the light detector are preferably placed in such a manner that their beam direction and line of sight, respectively, lie in a vertical plane parallel to the travelling direction. Hereby is attained that the sideways position of the track relative to the travelling direction can be determined without regard for the vertical distance of the light detector from the field.

Further preferred embodiments appear from the dependent claims 3-5.

The technique used in this connection is known per se in the cutting up of wood for measuring of surfaces.

It has, however, most surprisingly turned out to be possible to advantageously use this technique for detecting a track in a field.

The object is further met by a combination of an agricultural implement and a drive unit with a travelling direction, which is characterized in being provided with a laser light source, which in a beam direction exposes a line, and a light detector, which can take a picture with a certain resolution and which has a line of sight, mounted on a vehicle or implement with a travelling direction in such a manner that a line exposed by the laser light source in the field is transverse to the travelling direction, that the light detector aims at the line exposed by the laser light source, the line of sight of the light detector and the beam direction of the laser light source forming an angle in a plane transverse to the exposed line, and means for analyzing a picture of the exposed line taken by the light detector with a view to determining extreme value points, bends or the like characteristics in the picture of the line. The laser light source and the light detector are preferably mounted in a common holder adapted for releasable mounting on the agricultural implement or the drive unit.

The agricultural implement may be adapted to be connected with a drive unit in the form of a tractor carrying or towing the agricultural implement, or the agricultural implement may have a built-in drive unit and thus be self-propelling.

Finally, the object is met by means of a detecting unit comprising a housing adapted for mounting and comprising a laser light source, which in a beam direction may expose a line, and a light detector capable of taking a picture with a certain resolution and having a line of sight, the laser light source and the light detector being mounted in such a manner in the housing that their beam direction and line of sight, respectively, have an inclination relative to each other of 5-60°, preferably 10-20°, and that the laser light source and the light detector are spaced 5-100 cm apart, preferably 10-30 cm. Such a detecting unit may, for reasons of safety, in connection with its design for mounting be designed in such a manner that the laser light source cannot be actuated unless the detecting device is mounted.

The invention will now be explained in detail in the following by means of an example of an embodiment with reference to the schematic drawings, in which

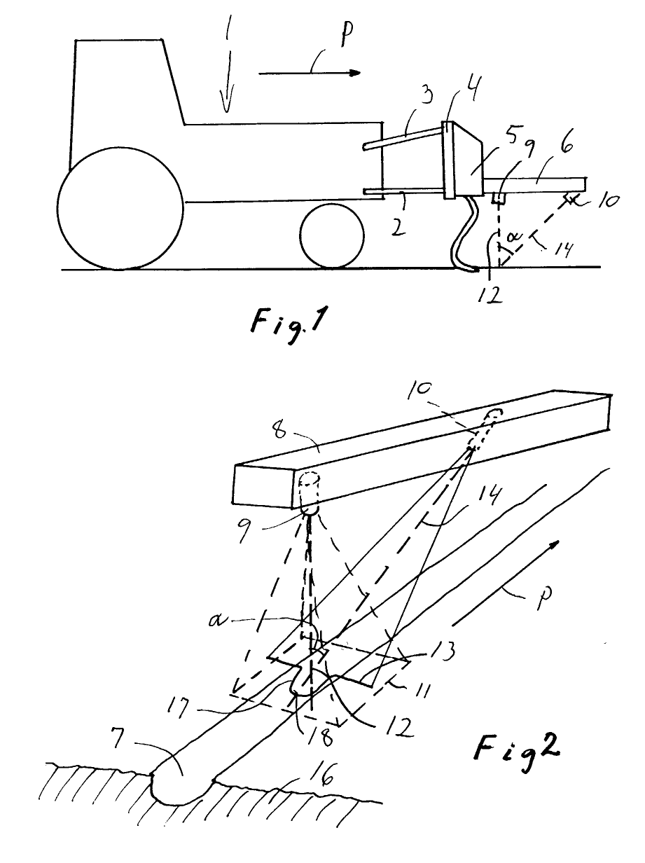

FIG. 1 is a lateral view of a tractor with an implement and a detecting device according to the invention, and

FIG. 2 a perspective view of the detecting device.

FIG. 1 shows a tractor 1 with a front lift with carrier arms 2 and a guide rod 3.

In the front lift a guidance frame 4 is suspended, in which a soil-engaging implement 5 is suspended, for instance a steerage hoe. By means of the steering frame 4 the implement 5 may be laterally and controllably displaced to position it relative to the field.

On the implement 5 a detecting device 6 is mounted with a view to detecting or censoring a track 7 in the field to control the position of the implement 5 relative to the track 7.

The detecting device comprises a housing 8, in which a light detector in the shape of a camera 9, for instance a video camera, and a laser light source or laser 10 are mounted. The camera 9 is mounted in such a manner that it has a vertical line of sight 12 and views a picture field 11 directly below. The laser 10 is for instance mounted ahead of the camera 9 relative to the travelling direction of the tractor indicated by arrow P. The laser 10 exposes a line 13 in the field perpendicularly to the travelling direction and within the picture field 11 of the camera 9, the beam direction 14 of the laser forming an angle α of approximately 45° with the line of sight 12, and the housing 8 is kept in a height above the soil which is approximately equal to the distance between the camera 9 and the laser 10, which may for instance be 40 cm.

FIG. 2 shows a section of the field, whereby the shape of a track 7 is seen in the cut area 16.

Due to the angle α between the line of sight 12 of the camera and the beam direction 14 of the laser 10, the camera will “see” a bulge 17 in the picture of the line 13. The apex point or the extreme value 18 of the bulge 17 indicates the bottom of the track 7, the positioning of which may then be determined by analysis of the picture taken by the camera 9 by means of adequate means known per se.

When the position of the bottom of the track 7 is determined, the lateral position of the implement 5 relative to the track 7 may be adjusted by means of the guidance frame 4.

By the invention is attained that the position of the bottom of the track may be determined irrespective of the profile of the track, a suitable picture analysis at suitable averaging over time making it possible to determine the position of the track as a whole and consequently the bottom thereof even in case of a partially ruined track.

The laser used has in the example an effect of 20 mW. The laser has for legislative reasons to be of safety class IIIA according to US-CDRH (Center for Devices and Radiological Health) and/or 3A according to IEC 60825-1 or better. The laser may depending on wave length and pulsing, if any, have an effect of up to 10 W, a laser of 500 mW in the near infrared (NIR) area being for instance usable.

It is to be understood that the above description of a concrete example of an embodiment does not aim at limiting the invention. Many variations may be made within the scope of the invention. Among others, the detecting device may be mounted behind the tractor instead of in front as shown in the drawing, the detecting device may be mounted on a towed implement and on the tractor itself. Furthermore, it is possible to expose more lines than one.

1. A method of detecting a track in the shape of an elongated furrow (7) or a ridge in a field, characterized in that a laser light source (10), which in a beam direction (14) exposes a line (13), and a light detector (9) capable of taking a picture with a certain resolution and having a line of sight (12), are mounted on a vehicle (1) or implement (5) with a travelling direction (P) in such a manner that a line (13) exposed by the laser light source (10) in the field is transverse to the travelling direction (P), that the light detector (9) aims at the line (13) exposed by the laser light source (10), the line of sight (12) of the light detector (8) and the beam direction (14) of the laser light source (10) forming an angle (a) in a plane transverse to the exposed line (13), that the light detector (9) takes a picture of the exposed line (13), and that the picture taken by the light detector (9) of the exposed line (13) in the field is analyzed with a view to determining extreme value points (18), bends or the like characteristics in the picture of the line (13).

2. A method according to claim 1, characterized in that the laser light source (10) and the light detector (9) are placed in such a manner that their beam direction (14) and line of sight (12), respectively, lie in a vertical plane parallel to the travelling direction (P).

3. A method according to claim 1 or 2, characterized in that the light detector (9) and the laser light source (10) are positioned in such a manner that their line of sight (12) and beam direction (14), respectively, have an inclination (α) relative to each other of 5-60°, preferably 10-20°.

4. A method according to claims 1-3, characterized in that the light detector (9) is placed in such a manner that its line of sight (12) is vertical.

5. A method according to claims 1-4, characterized in that as a laser light source a laser of class IIIA according to US-CDRH (Center for Devices and Radiological Health) is used or a better one.

6. A combination of an agricultural implement (5) and a drive unit (1) with a travelling direction (P), characterized in being provided with a laser light source (10), which in a beam direction (14) exposes a line (13), and a light detector (9) capable of taking a picture with a certain resolution and having a line of sight (12), mounted on the combination in such a manner that a line (13) exposed by the laser light source (10) in the field is transverse to the travelling direction (P), that the light detector (9) aims at the line (13) exposed by the laser light source (10), the sight line (12) of the light detector (8) and the beam direction (14) of the laser light source (10) forming an angle (α) in a plane transverse to the exposed line (13), and means for analysing a picture of the exposed line taken by the light detector with a view to determining extreme value points, bends or the like characteristics in the picture of the line.

7. A combination according to claim 6, characterized in that the laser light source (10) and the light detector (9) are mounted in a common holder (8) adapted for releasable mounting on the agricultural implement (5) or the drive unit (1).

8. A detecting unit comprising a housing (8) adapted for mounting and comprising a laser light source (10), which in a beam direction (14) is capable of exposing a line (13), and a light detector (9), capable of taking a picture with a certain resolution and having a line of sight (12), the laser light source (10) and the light detector (9) being mounted in such a manner in the housing (8) that their beam direction (14) and line of sight, respectively, have an inclination (α) relative to each other of 5-60°, preferably 10-20° and that the laser light source (10) and the light detector (9) are spaced 5-100 cm apart, preferably 10-30 cm.
